(19) United States
(12) Patent Application Publication
(10) Pub. No.: US 2006/0165435 A1
(43) Pub. Date: Jul. 27, 2006

(54) A PROCESS CARTRIDGE FOR AN IMAGE FORMING APPARATUS

(75) Inventors: Christopher Paul Mercer, Dongara (AU); Samuel Wai Keung Tsui, Shenzen (CN); Chun Cho Chan, Shenzen (CN)

Correspondence Address: GCC IP PTY LTD, P. O. BOX 2920, GERALDTON, WA 6531, AU

(73) Assignee: GCC IP PTY LTD, Geraldton (AU)

(21) Appl. No.: 10/905,928

(22) Filed: Jan. 27, 2005

(51) Int. Cl. G03G 21/18

(52) U.S. Cl. 399/113

(57) ABSTRACT

The invention relates to a process cartridge for an image forming apparatus, wherein the cartridge includes frame and a removable toner hopper that is connected to the frame by a screw. The use of a screw as the means for attaching the hopper to the cartridge frame simplifies assembly and remanufacture/refilling of the cartridge.

### FIELD OF THE INVENTION

The invention relates to a method of attaching a removable toner hopper to a process cartridge for an electrophotographic device, and also to an apparatus for performing the method. The method is applicable to process cartridges for laser printers, laser photocopiers and laser facsimile machines, and will be described hereinafter with reference to such applications. However, it will be appreciated that the invention is not limited to this particular field of use.

### BACKGROUND TO THE INVENTION

Toner cartridges for laser printers, copiers and multi function devices are well known in the art. Typically, toner cartridges comprise integral toner hoppers for containing toner that is used to develop an electrostatic latent image on a photosensitive member. However, in this environmentally conscious age, some toner cartridges now include replaceable toner hoppers. The replaceable hoppers are designed to be removed and replaced when empty with a new hopper, thereby minimising wastage by allowing longer-life components of the cartridge to be reused for several hopper lives.

As the hoppers are regularly removed and replaced, it is important that the method of attachment of the hopper to the cartridge is quite simple. With this in mind, it is noted that some prior art cartridges have removable hoppers that are cumbersome to remove and replace. Also, some prior art cartridges have a removable hopper that is inadequately connected to the cartridge, which can cause toner leakage and premature dislocation of the hopper and cartridge.

Prior art methods of attaching toner hoppers to cartridge frames have included the use of clips on the hopper that engage complementary portions on the hopper frame. However, the clips are prone to breaking during attachment of the toner hopper. Other methods have used relatively complicated and expensive attachment mechanisms, such at the provision of guide rails on the cartridge frame, which co-operate with bearing shafts that project from opposite sides of the hopper to be supported on the guide rails to direct the hopper into correct mating alignment with the frame.

It is an object of the present invention to overcome or ameliorate one or more of the disadvantages of the prior art, or at least to provide a useful alternative thereto.

### SUMMARY OF THE INVENTION

Accordingly, in a first aspect the invention provides a process cartridge for an image forming apparatus, said process cartridge comprising:

a cartridge frame;

a toner bearing member rotatably mounted to the frame;

a toner hopper for supplying toner to the toner bearing member;

wherein the toner hopper is removably connected to the cartridge frame by at least one screw.

Preferably, a threaded portion of the screw fasteningly engages the toner hopper. However, in some embodiments, the threaded portion fasteningly engages the cartridge frame. In a preferred form, at least one boss is provided on the toner hopper and is adapted for fastening engagement by the at least one screw. Preferably, the boss includes a central bore of smaller diameter than an outer diameter of the threaded portion of the screw, such that in use the threaded portion is engaged within the bore. More preferably, the boss is located on an external surface of the hopper. Preferably, the boss is integrally moulded as part of the toner hopper. It is preferred that the screw be self-tapping.

Preferably, the cartridge frame includes an aperture that is adapted to fit around the boss. More preferably, the aperture is provided on a projecting tab. In a preferred embodiment, the screw head is oversized with respect to the aperture and boss diameter, so as to removably connect the hopper to the frame.

Preferably, the boss is located in a position, relative to other cartridge frame elements, that ensures that the screw is substantially unobstructed during removal and installation.

Preferably, more than one screw and corresponding boss is provided. More preferably, the bosses are spaced apart along a longitudinal axis of the hopper.

Preferably, the cartridge frame includes an hopper retaining portion that is adapted to extend around the hopper to stabilise the hopper when connected to the frame. More preferably, the retaining portion stabilises the hopper against movement in at least two planes. In a preferred form, however, the retaining portion stabilises the hopper against movement in three planes.

Preferably, the cartridge frame includes an upper and a lower sub-frame. More preferably, the upper sub-frame includes the hopper retaining portion. Preferably also, the lower sub-frame is adapted for engagement by the at least one screw to removably connect the toner hopper to the cartridge frame.

According to a second aspect, the invention provides a method of manufacturing or remanufacturing a process cartridge wherein the process cartridge comprises a cartridge frame, a toner bearing member rotatably mounted to the frame and a toner hopper for supplying toner to the toner bearing member, the method including the steps of:

removably connecting the toner hopper to the cartridge frame using a screw.

Preferably, a threaded portion of the screw is adapted to fasteningly engage the toner hopper. However, in some embodiments, the threaded portion fasteningly engages the cartridge frame. In a preferred form, at least one boss is provided on the toner hopper and is adapted for fastening engagement by the at least one screw. Preferably, the boss includes a central bore of smaller diameter than an outer diameter of the threaded portion of the screw, such that in use the threaded portion is engaged within the bore. More preferably, the boss is located on an external surface of the hopper. Preferably, the boss is integrally moulded as part of the toner hopper. It is preferred that the screw be self-tapping.

Preferably, the cartridge frame is provided with an aperture that is adapted to fit around the boss. More preferably, the aperture is provided on a projecting tab. In a preferred embodiment, the screw head is oversized with respect to the aperture and boss diameter, so as to removably connect the hopper to the frame.

Preferably, the boss is located in a position, relative to other cartridge frame elements, that ensures that the screw is substantially unobstructed during removal and installation.

Preferably, more than one screw and corresponding boss is provided. More preferably, the bosses are spaced apart along a longitudinal axis of the hopper.

Preferably, the cartridge frame is provided with an hopper retaining portion that is adapted to extend around the hopper to stabilise the hopper when connected to the frame. More preferably, the retaining portion stabilises the hopper against movement in at least two planes. In a preferred form, however, the retaining portion stabilises the hopper against movement in three planes.

Preferably, the cartridge frame includes an upper and a lower sub-frame. More preferably, the upper sub-frame includes the hopper retaining portion. Preferably also, the lower sub-frame is adapted for engagement by the at least one screw to removably connect the toner hopper to the cartridge frame.

Throughout this document, unless otherwise indicated to the contrary, the terms “comprising”, “consisting of”, and the like, are to be construed as non-exhaustive, or in other words, as meaning “including, but not limited to”.

### BRIEF DESCRIPTION OF THE DRAWINGS

The invention will now be described, by way of example only, with reference to the accompanying drawings, in which:

FIG. 1 is a perspective view of a process cartridge according to the invention, shown with the drum cover closed;

FIG. 2 is a perspective view of a process cartridge according to the invention, shown with the drum cover open;

FIG. 3 is a front view of the cartridge of FIG. 1;

FIG. 4 is a rear view of the cartridge of FIG. 1;

FIG. 5 is top view of the cartridge of FIG. 1;

FIG. 6 is a bottom view of the cartridge of FIG. 1;

FIG. 7 is a perspective view of a toner hopper of the cartridge of FIG. 1;

FIG. 8 is a front view of the hopper of FIG. 7;

FIG. 9 is a rear view of the hopper of FIG. 7;

FIG. 10 is a top view of the hopper of FIG. 7;

FIG. 11 is a bottom view of the hopper of FIG. 7;

FIG. 12 is a right side view of the hopper of FIG. 7;

FIG. 13 is a left view of the hopper of FIG. 7;

FIG. 14 is a perspective view of two sub-frames that comprise the lower frame of the cartridge of FIG. 1;

FIG. 15 is an assembled perspective view of the two sub-frames of FIG. 14; and

FIG. 16 is a perspective view of the upper frame of the cartridge of FIG. 1.

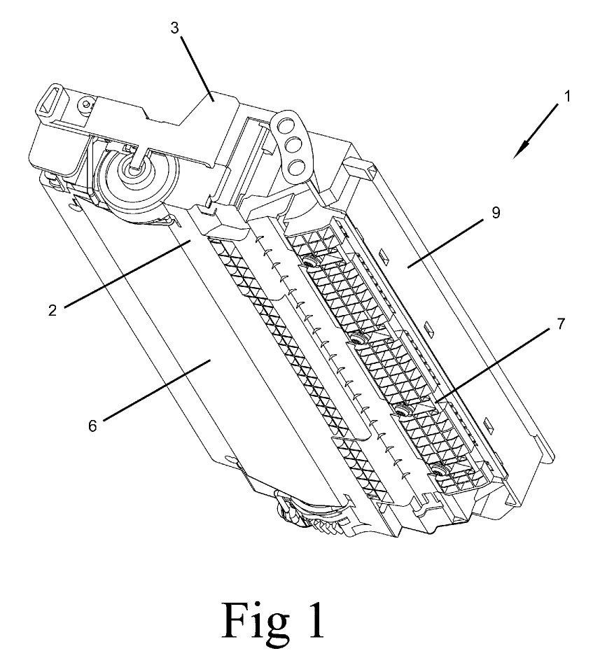

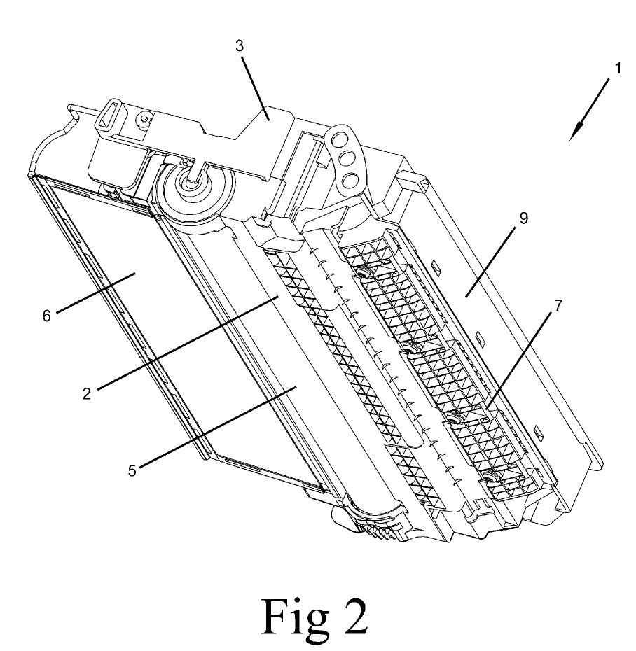

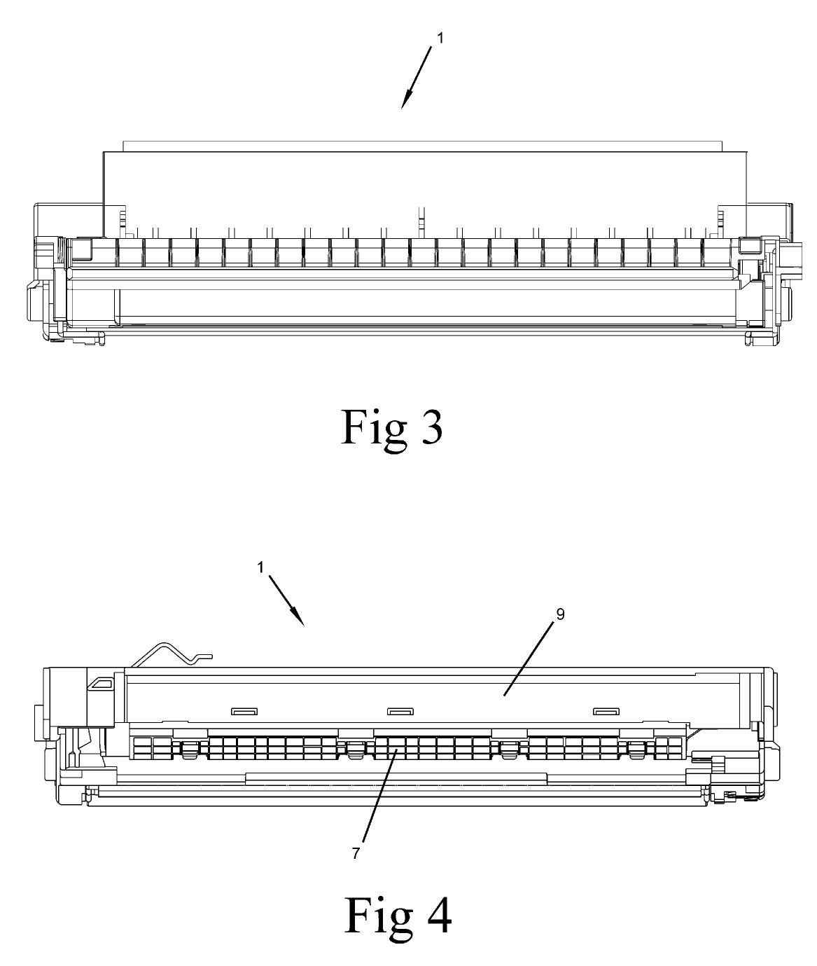

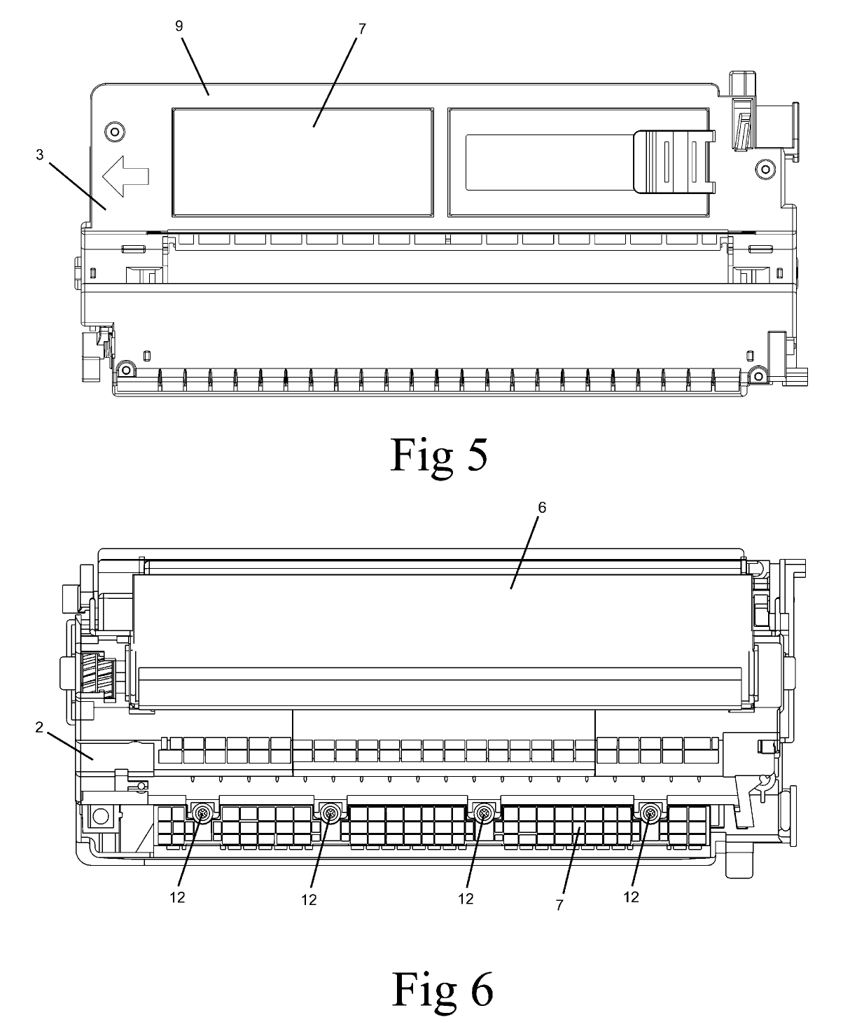

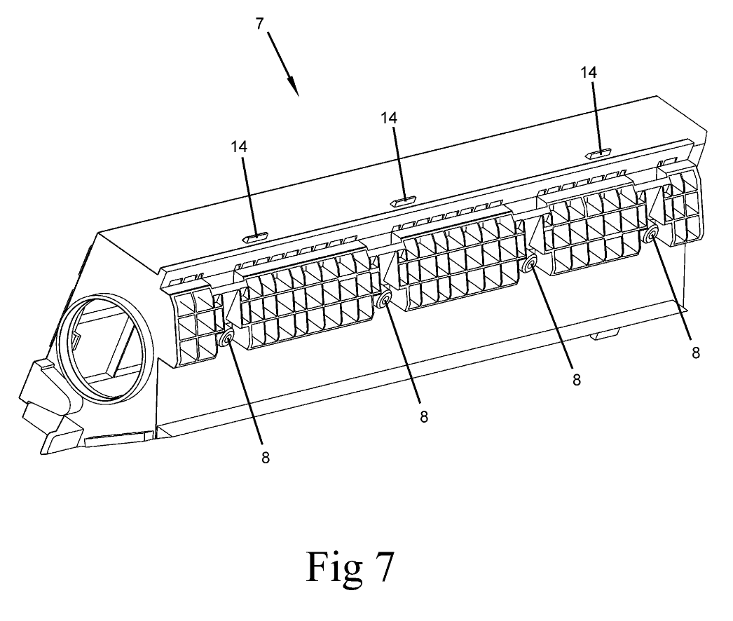

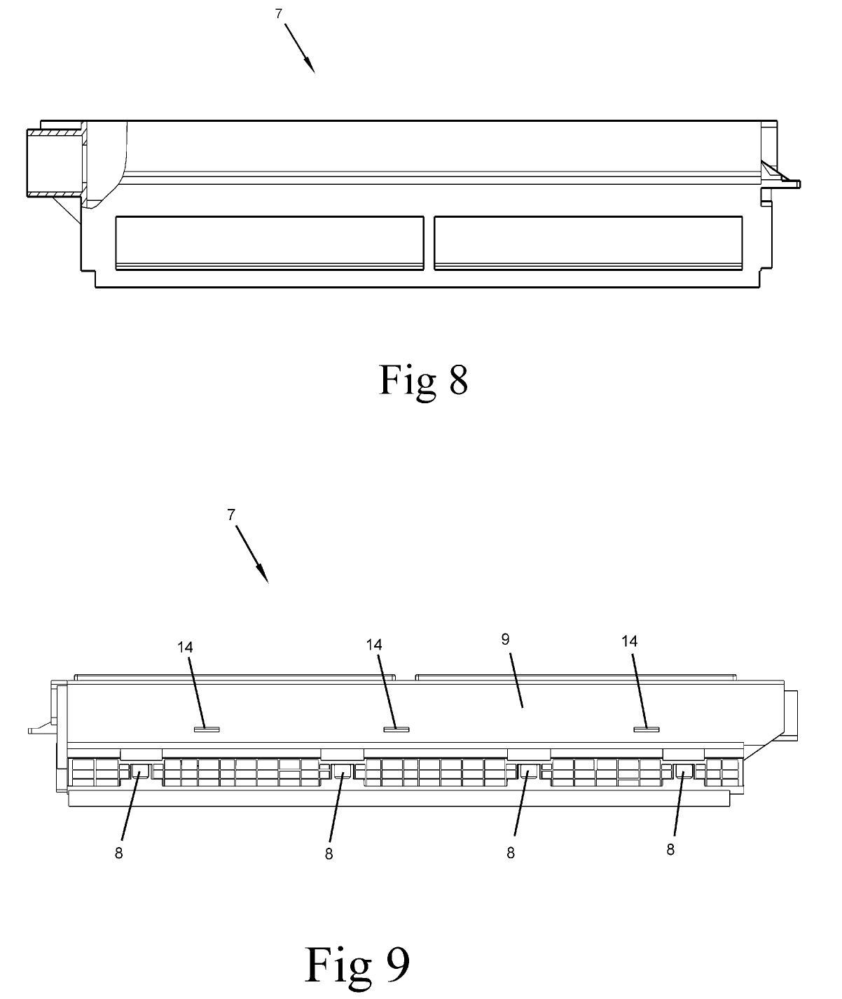

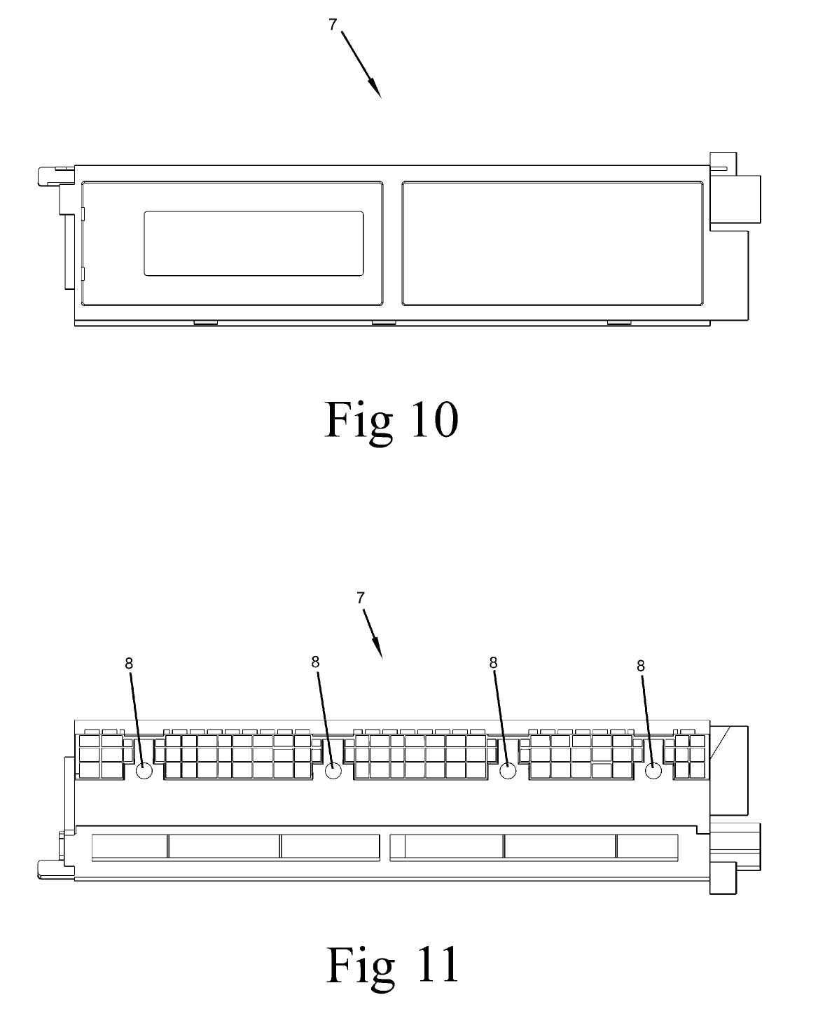

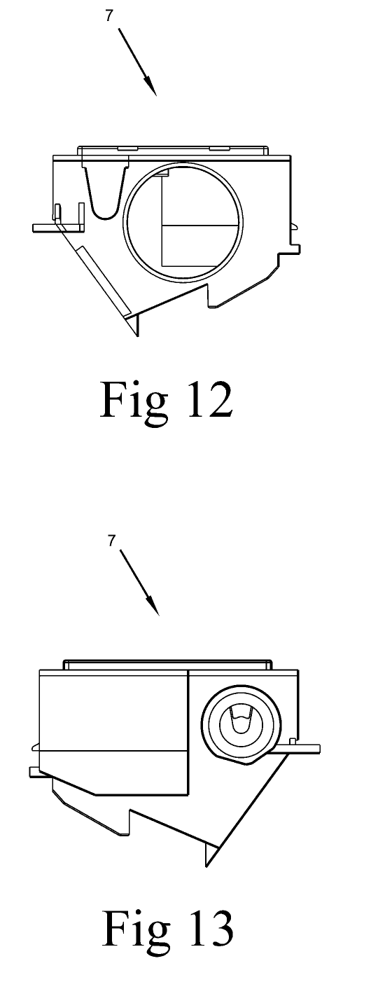

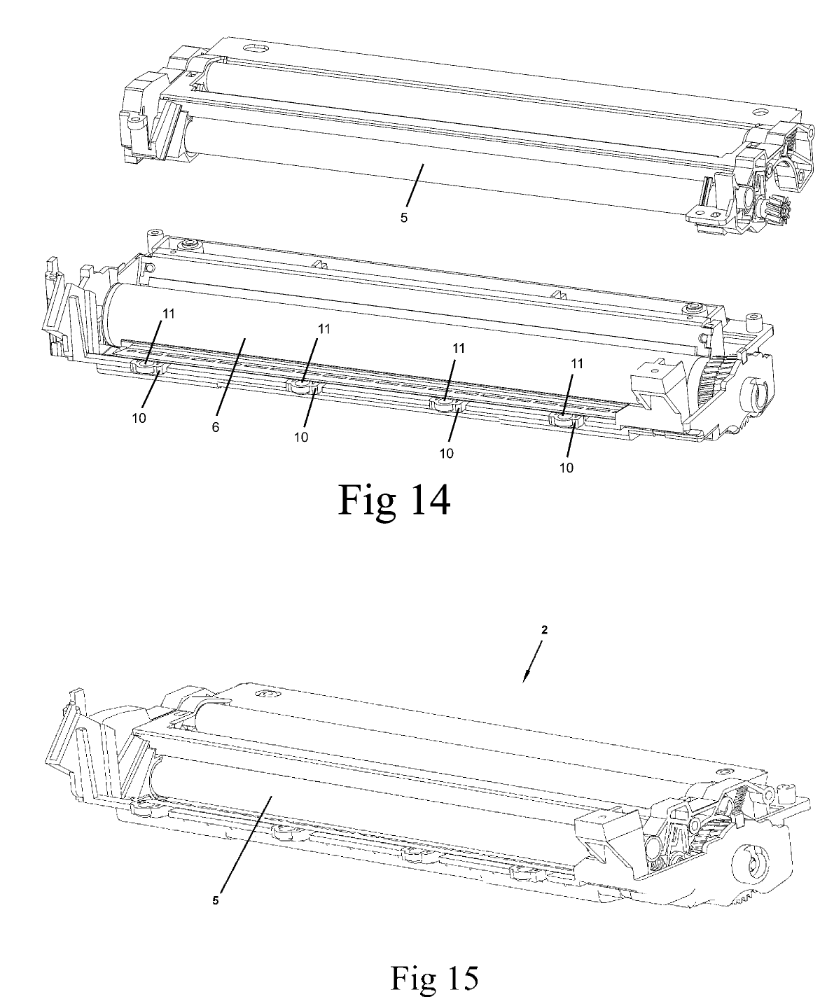

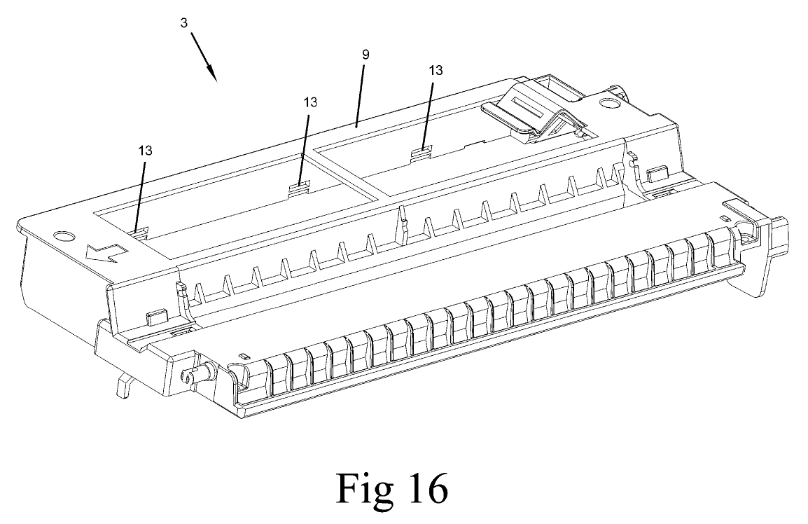

### PREFERRED EMBODIMENTS OF THE INVENTION

As will be understood by those skilled in the art, process cartridges can take the form of drum cartridges, developing cartridges and unitary cartridges. A drum cartridge is a cartridge that contains a photosensitive drum, upon which is formed a latent image for subsequent development by a developer. A developing cartridge is a cartridge that includes process elements for developing the latent image, such as a developing roller. A unitary cartridge is a cartridge that includes the drum and the process elements responsible for developing the latent image.

The present invention is applicable to developing cartridges and unitary cartridges. However, the following description relates to a unitary cartridge.

Referring to the drawings, the cartridge 1 includes a cartridge frame which houses various process elements, such as a photosensitive drum and a developing roller. The cartridge frame is formed from interengageable lower 2 and upper 3 sub-frames. The lower frame is positioned lower than the upper frame when the cartridge is mounted within a host machine.

The developer roller 4 and drum 5 are rotatably mounted to the lower frame 2. A drum cover 6 is hingedly connected to the upper frame 3 and is movable between an open position in which the drum is exposed and a closed position in which the drum is covered.

A toner hopper 7 is removably connected to a rear portion of the lower frame 2 for supplying toner to the developing roller 4. A plurality of axially spaced bosses 8 extend from an external surface of the hopper 7. The bosses are integrally moulded as part of the toner hopper and each boss includes a central bore (not shown).

The upper sub-frame 3 includes an hopper retaining portion 9 that is adapted to extend around the hopper 7 to stabilise the hopper when connected to the frame. The retaining portion extends across the top, rear and sides of the hopper, thereby to stabilise the hopper against movement in all three planes.

The lower sub-frame 2 includes projecting tabs 10 that extend along part of an underside of the hopper. Each of the tabs includes an aperture 11 that is adapted to fit around a respective one of the bosses 8.

A plurality of self-tapping screws 12 are used to connect the hopper 7 to the cartridge frame. The screws 12 extend through the apertures 11 provided in the projecting tabs 10 and into the bores provided in the bosses 8 on the hopper. The screws 12 have heads that are oversized with respect to the tab apertures and boss diameters. When installed, threaded portions of the screws engage with the bores in the hopper bosses, thereby to draw the heads of the screws against the projecting tabs to securely retain the hopper to the lower sub-frame 2. In this respect, it is noted that the diameter of the boss bores is slightly smaller than the diameter of the threaded portion of the screws, thereby to provide adequate pull-out resistance for the screws.

The bosses 8 are located in a position relative to the other cartridge frame elements that ensures that the screws 12 are substantially unobstructed during removal and installation.

It will be appreciated that in alternative embodiments the screws 12 can engage the cartridge frame rather than engaging the toner hopper. In such cases, the bosses might be located on the cartridge frame, rather than on the toner frame as described above, and the screws might connect correspondingly configured portions of the toner hopper to these bosses.

The hopper 7 is attached to the lower sub-frame 2 before the upper sub-frame 3 is connected to the lower sub-frame. After the screws 12 have been inserted to hold the hopper to the lower sub-frame, the upper sub-frame is placed on top of the lower sub frame and is connected to the lower sub-frame by screws (not shown). When connecting the upper sub-frame to the lower sub-frame, the hopper retaining portion 9 is positioned around the hopper 7, and apertures 13 on the rear of the hopper retaining portion are engaged with projecting tabs 14 on the rear of the hopper to engage the upper sub-frame 3 with the hopper.

The hopper 7 is removed by first removing the screws (not shown) that hold the upper sub frame 3 to the lower sub-frame 2. Then, the rear wall 15 of the upper sub-frame is urged outwardly with respect to the hopper 7 so as to disengage the apertures 13 from the projecting tabs 14 and the upper sub-frame is simply lifted off the lower sub frame. Once the upper sub-frame has been removed, the hopper is detached from the lower sub-frame by removing the hopper screws 12.

It will be appreciated that the illustrated cartridge provides a rugged interconnection between the removable hopper and cartridge frame. The hopper is also relatively simple to install and remove, thereby promoting re-use of the other cartridge components, which lowers costs for end users and also benefits the environment. The simple connection between the hopper and frame also reduces the time taken by cartridge recyclers/refillers to remove and replace or refill the hopper.

It will be appreciated that while the invention has been described with reference to specific examples, it may also be embodied in many other forms.

What is claimed is:

1. A process cartridge for an image forming apparatus, said process cartridge comprising:
a cartridge frame;
a toner bearing member rotatably mounted to the frame;
a toner hopper for supplying toner to the toner bearing member;
wherein the toner hopper is removably connected to the cartridge frame by at least one screw.

2. A process cartridge as defined in claim 1, wherein a threaded portion of the screw fasteningly engages the toner hopper.

3. A process cartridge according to claim 1, wherein the screw is self-tapping.

4. A process cartridge as defined in claim 1, wherein a threaded portion of the screw fasteningly engages the cartridge frame.

5. A process cartridge as defined in claim 1, further comprising at least one boss provided on the toner hopper and adapted for fastening engagement by the at least one screw.

6. A process cartridge as defined in claim 5, wherein said boss comprises a central bore.

7. A process cartridge according to claim 6, wherein the diameter of the bore is smaller than an outer diameter of a threaded portion of the screw, such that in use the threaded portion is engaged within the bore.

8. A process cartridge according to claim 5, wherein the boss is located on an external surface of the hopper.

9. A process cartridge according to claim 5, wherein the boss is integrally moulded as part of the toner hopper.

10. A process cartridge according to claim 5, wherein the frame includes an aperture that is adapted to fit around the boss.

11. A process cartridge according to claim 10, wherein the aperture is provided on a projecting tab.

12. A process cartridge according to claim 10, wherein the screw has a head that is oversized with respect to an outer diameter of the aperture and boss, so as to removably connect the hopper to the frame.

13. A process cartridge according to claim 5, wherein the boss is located in a position, relative to other cartridge frame elements, that ensures that the screw is substantially unobstructed for ease of its removal and installation.

14. A process cartridge according to claim 5, wherein more than one said screw and corresponding said boss is provided.

15. A process cartridge according to claim 14, wherein the bosses are spaced apart along a longitudinal axis of the hopper.

16. A process cartridge according to claim 1, wherein the cartridge frame includes an hopper retaining portion that is adapted to extend around the hopper to stabilise the hopper when connected to the frame.

17. A process cartridge according to claim 16, wherein the retaining portion stabilises the hopper against movement in at least two planes.

18. A process cartridge according to claim 16, wherein the retaining portion stabilises the hopper against movement in three planes.

19. A process cartridge according to claim 1, wherein the cartridge frame includes an upper and a lower sub-frame.

20. A process cartridge according to claim 19, wherein the lower sub-frame is adapted for engagement by the at least one screw to removably connect the toner hopper to the cartridge frame.

21. A process cartridge according to claim 16, wherein the cartridge frame includes an upper and a lower sub-frame and wherein the upper sub-frame includes the hopper retaining portion.

22. A process cartridge according to claim 21, wherein the lower sub-frame is adapted for engagement by the at least one screw to removably connect the toner hopper to the cartridge frame.

23. A method of manufacturing or remanufacturing a process cartridge, wherein the process cartridge comprises a cartridge frame, a toner bearing member rotatably mounted to the frame and a toner hopper for supplying toner to the toner bearing member, the method including the steps of:
removably connecting the toner hopper to the cartridge frame using a screw.

24. A method as defined in claim 23, wherein a threaded portion of the screw fasteningly engages the toner hopper.

25. A method according to claim 23, wherein the screw is self-tapping.

26. A method as defined in claim 23, wherein a threaded portion of the screw fasteningly engages the cartridge frame.

27. A method as defined in claim 23, including the additional step of providing at least one boss on the toner hopper, wherein the boss is adapted for fastening engagement by the at least one screw.

28. A method as defined in claim 27, wherein said boss is provided with a central bore.

29. A method according to claim 28, wherein the diameter of the bore is smaller than an outer diameter of a threaded portion of the screw, such that in use the threaded portion is engaged within the bore.

30. A method according to claim 27, wherein the boss is provided on an external surface of the hopper.

31. A method according to claim 27, including the additional step of integrally moulding the boss as part of the toner hopper.

32. A method according to claim 27, including the additional step of providing the frame with an aperture that is adapted to fit around the boss.

33. A method according to claim 32, wherein the aperture is provided on a projecting tab.

34. A method according to claim 32, including the additional step of providing the screw with a head that is oversized with respect to an outer diameter of the aperture and boss, so as to removably connect the hopper to the frame.

35. A method according to claim 27, including the additional step of locating the boss in a position, relative to other cartridge frame elements, that ensures that the screw is substantially unobstructed for ease of its removal and installation.

36. A method according to claim 27, wherein more than one said screw and corresponding said boss is provided.

37. A method according to claim 36, including the additional step of axially spacing the bosses apart along a longitudinal axis of the hopper.

38. A method according to claim 23, including the additional step of stabilising the hopper when connected to the frame.

39. A method according to claim 38, wherein the hopper is stabilised against movement relative to the frame in at least two planes.

40. A method according to claim 38, wherein the hopper is stabilised against movement relative to the frame in three planes.

41. A method according to claim 38, wherein the hopper is stabilised against movement relative to the frame by the provision of an hopper retaining portion on the cartridge frame, which hopper retaining portion is adapted to extend around the hopper.

42. A method according to claim 23, including the additional step of providing the cartridge frame with an upper and a lower sub-frame.

43. A method according to claim 42, including the additional step of removably connecting the hopper to the lower sub-frame by the at least one screw.

44. A method according to claim 41, wherein the cartridge frame includes an upper and a lower sub-frame and wherein the upper sub-frame includes the hopper retaining portion.

45. A method according to claim 44, wherein the lower sub-frame is adapted for engagement by the at least one screw to removably connect the toner hopper to the cartridge frame.
